(19) United States
(12) Patent Application Publication
(10) Pub. No.: US 2002/0180666 A1
(43) Pub. Date: Dec. 5, 2002

(54) Driving method of a plasma display panel

(76) Inventor: Se Don Kim, Kyungsangbuk-do (KR)

Correspondence Address: Notaro & Michalos, Suite 6902, 350 Fifth Avenue, New York, NY, 10118-6985, US

(21) Appl. No.: 10/148,330

(22) PCT Filed: Nov. 30, 2000
(86) PCT No.: PCT/KR00/01382

(30) Foreign Application Priority Data
Nov. 30, 1999 (KR) 1999/54060

(51) Int. Cl. G09G 3/28

(52) U.S. Cl. 345/60

(57) ABSTRACT

The present invention provides a method of driving a plasma display panel using frequency-modulation. The method of driving a plasma display panel, said method comprising the steps of: storing a horizontal synchronization signal, a vertical synchronization signal and a video signal to be inputted; modulating a frame frequency to be inputted to a lower level and lengthening the length of a unit frame; and dividing one frame of a video signal to be inputted into a plurality of subfields and giving the divided subfields a predetermined display period, thereby displaying multiple gradations in combination with such subfields, thereby reducing a border line of a dynamic picture in a screen and achieving a fine display quality.

### TECHNICAL FIELD

The present invention relates generally to a method of driving a plasma display panel using a method of modulating a frame frequency, and more particularly, to the method of driving a plasma display panel which can increase the number of subfields by modulating the frame frequency to a lower level, thereby reducing a border line of a dynamic picture in a screen and achieving a fine display quality.

### BACKGROUND ART

FIG. 1 schematically illustrates subfields into which each frame is conventionally divided in a plasma display panel when a frequency is 60 Hz.

In the conventional method of displaying gradations in the plasma display panel by discharging at a sustain discharge step after an address discharge, a frequency of 60 Hz is generally used as a frame frequency in the plasma display panel in FIG. 1.

In this case of using 60 Hz as the frame frequency, 60 frames are made for one second, and about a time of 16.7 ms is assigned to each of the 60 frames, thus the number of subfields necessary to display the gradation in the general plasma display panel is limited by a time of 16.7 ms assigned to the frame.

Therefore, each 16.7 ms-assigned frame can be divided into subfields in maximum, and, in case of a driving method of an upper-and-lower separate type, into 14 subfields in maximum.

In general, one of the best methods for reducing a border line of a dynamic picture in a screen and achieving a fine display quality is to increase the number of subfields dividing each frame.

### SUMMARY OF THE INVENTION

However, according to the above-described construction and acting of the conventional plasma display panel, there is one problem that, since each frame can be divided into 10 subfields in maximum in case of a full line driving method by using 60 Hz as the frame frequency in the plasma display panel, there is a limitation in reducing a border line of a dynamic picture in a screen and it is difficult to realize a fine display quality.

Accordingly, in order to the above discussed problems, the present invention provides a method of driving a plasma display panel which can increase a time to be assigned to each frame and/or the number of subfields by modulating the frame frequency to a lower level, thereby increasing gradations or greyscales, reducing a border line of a dynamic picture in a screen and achieving a fine display quality.

Accordingly, in order to the above discussed problems, the present invention provides a method of driving a plasma display panel, said method comprising the steps of: storing a horizontal synchronization signal, a vertical synchronization signal and a video signal to be inputted; modulating a frame frequency to be inputted to a lower level and lengthening the length of a unit frame; and dividing one frame of a video signal to be inputted into a plurality of subfields and assigning the divided subfields a predetermined display period, thereby displaying multiple gradations in combination with such subfields, thereby reducing a border line of a dynamic picture in a screen and achieving a fine display quality.

In case the frame frequency to be used in the panel is modulated to a lower frequency of 40 Hz, a time of 25 ms is assigned to each frame, and each frame for a time of 25 ms to be assigned to can be divided into 15 subfields.

### BRIEF DESCRIPTION OF THE DRAWINGS

FIG. 1 schematically illustrates subfields into which each frame is conventionally divided in a plasma display panel when a frequency is 60 Hz.

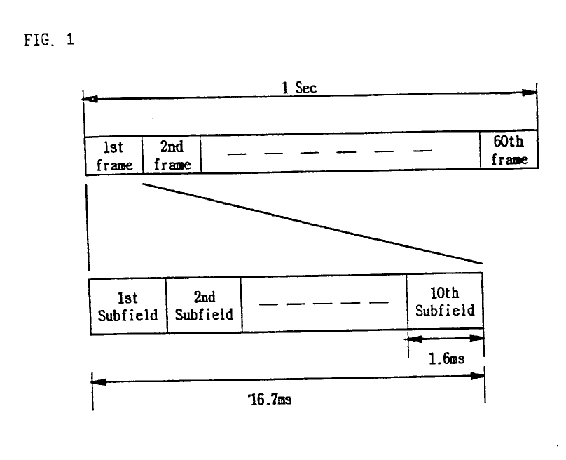

FIG. 2 schematically illustrates a block diagram of a circuit for explaining a method of driving a plasma display panel according to one embodiment of the present invention.

FIG. 3 schematically illustrates the subfields into which each frame is divided in a plasma display panel when a frame frequency is 40 Hz using a method of driving a plasma display panel according to one embodiment of the present invention.

FIG. 4 schematically illustrates a block diagram of a circuit for explaining a method of driving a plasma display panel according to another embodiment of the present invention.

### DETAILED DESCRIPTION OF THE PREFERRED EMBODIMENTS

Now, preferred embodiments of the present invention will be described in detail with reference to the accompanying drawings hereinafter.

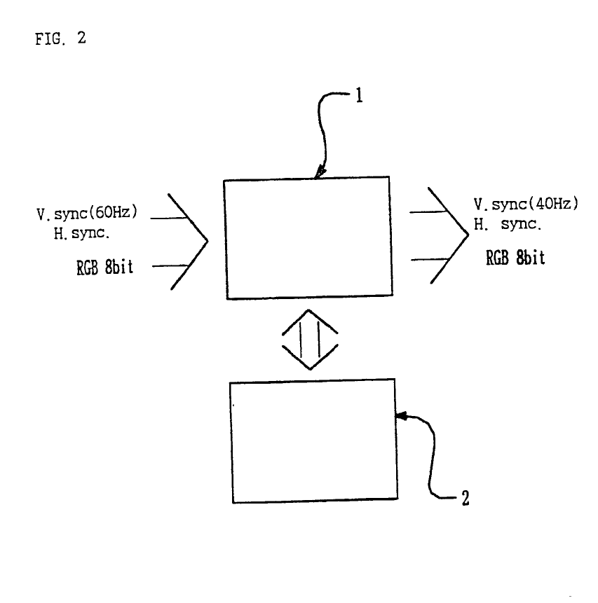

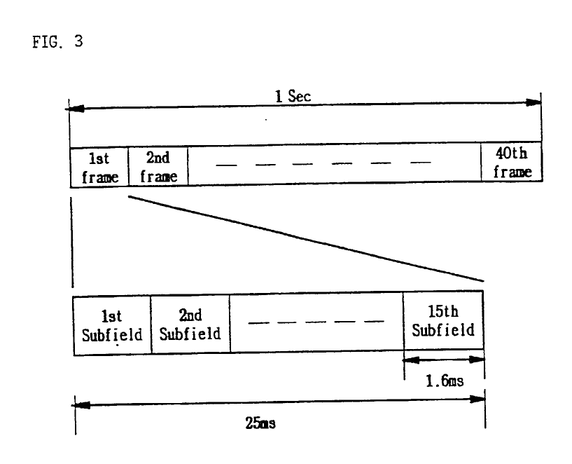

Schematic construction for explaining a method of driving a plasma display panel according to one embodiment of the present invention is shown in FIG. 2. And FIG. 3 shows subfields into which each frame is divided in a plasma display panel when a frame frequency is 40 Hz using a method of driving a plasma display panel according to one embodiment of the present invention.

In a method of modulating a frame frequency in a plasma display panel, as shown in FIG. 2, horizontal/vertical synchronization signals of 60 Hz and RGB signals of 8 bits are inputted to a frequency modulation means 1, and the horizontal/vertical synchronization signals of 60 Hz and the RGB signals of 8 bits inputted to a frequency modulation means 1 are outputted to a buffer means 2.

And, in the buffer means 2, to which the horizontal/vertical synchronization signals of 60 Hz and the RGB signals of 8 bits are inputted from the frequency modulation means 1, 3 frame data are selected into 2 frame data, which are outputted to the frequency modulation means 1, and horizontal/vertical synchronization signals of 40 Hz, modulated from a frequency of 60 Hz, and RGB signals of 8 bits are outputted to a driving means(not shown). That is, for 3/60 second, RGB signals of 8 bits of 3 frames and three horizontal synchronization signals are modulated to RGB signals of 8 bits of 2 frames and two horizontal synchronization signals, which are outputted.

Therefore, a frame frequency used in a plasma display panel is modulated to 40 Hz, and as shown in FIG. 3, 40 frames are made for a second, thus about 25 ms is assigned to each of the 40 frames. That is, in case of the whole line driving method, about a time of 25 ms is assigned to each frame, thus it is possible to divide each frame into about 15 subfields of 1.6 ms in average.

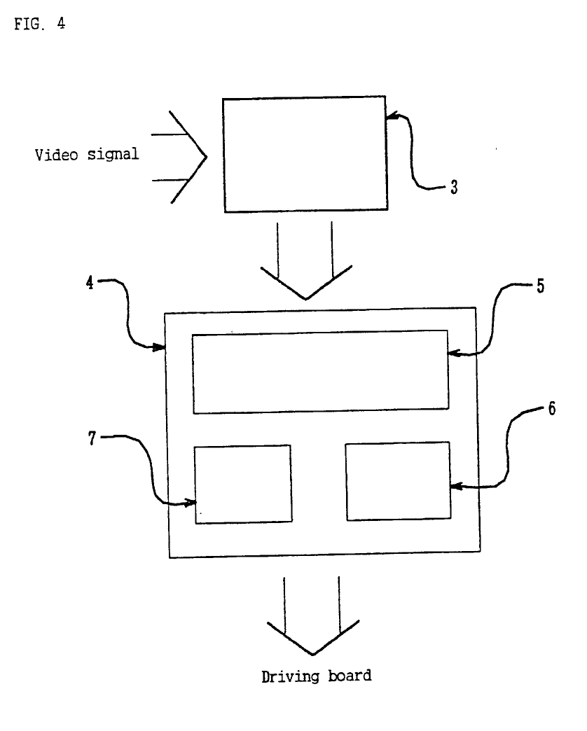

Meanwhile, schematic construction for explaining a method of driving a plasma display panel according to another embodiment of the present invention is shown in FIG. 4. In a method of driving a plasma display panel shown in FIG. 4, an A/V board means 3 and a modulation means 4 are included and the modulation means 4 comprises a sync signal and data modulation means 5, a timing means 6 and a memory means 7.

The video signals are inputted to the A/V board means 3, in which the inputted video signals are separated into sync signals and digital data, said sync signals -and digital data being outputted to the sync signal and data modulation means 4. In the sync signal and data modulation means 4, the inputted sync signals and digital data are modulated and outputted to the timing means 6 and the memory means 7. From the timing means 6, the modulated sync signal and data are outputted to driving means(not shown) in compliance with timing.

Further, in said memory means 7, the modulated sync signal and data are modulated to a memory for driving, which is outputted to driving means (not shown). In the driving means, which receive signals inputted from the timing means 6 and the memory means 7, driving signals for a plasma display panel are outputted.

Accordingly, by modulating the frame frequency of 60 Hz to be conventionally used in a plasma display panel to a lower level of 40 Hz, a time assigned to each frame increases from 16.7 ms to 25 ms, thereby being capable of increasing the number of subfields which each frame is divided into.

By the above-described construction and acting of the method of driving a plasma display panel in accordance with preferred embodiments of the present invention, the number of subfields to be divided in each frame used in a plasma display panel increase, thereby being capable of increasing gradations or greyscales and reducing a border line of a dynamic picture in a screen and achieving a fine display quality.

Additional advantages and modifications will readily occur to those skilled in the art. Therefore, the invention in its broader aspects is not limited to the specific details and representative embodiments shown and described herein, and various modifications can be made without departing from the spirit or scope of the general inventive concept as defined by the appended claims and their equivalent.

1. A method of driving a plasma display panel, said method comprising the steps of:
storing a horizontal synchronization signal, a vertical synchronization signal and a video signal to be inputted;
modulating a frame frequency to be inputted to a lower level and lengthening the length of an unit frame; and
dividing one frame of a video signal to be inputted into a plurality of subfields and giving the divided subfields a predetermined display period, thereby displaying multiple gradations in combination with such subfields.

2. The method of driving a plasma display panel according to claim 1, wherein a frame frequency modulated to about two third of the frame frequency to be inputted, thereby increasing the number of the divided subfields.

3. The method of driving a plasma display panel according to claim 1, wherein said frame frequency to be inputed is 60 Hz, and the frame frequency to be modulated 40 Hz.

4. The method of driving a plasma display panel in claims 1 and 2, wherein the number of said divided subfields is 12 or more.
